(19) United States
(12) Patent Application Publication
(10) Pub. No.: US 2012/0162440 A1
(43) Pub. Date: Jun. 28, 2012

(54) SYSTEM AND METHOD FOR PERFORMING AN AUTOMATED SET TOP BOX TEST

(75) Inventors: Leo Wu, Irvine, CA (US); Diem V. Nguyen, Anaheim, CA (US); Huy Q. Tran, Westminster, CA (US); Manuel J. Ham, Downey, CA (US); Duc V. Tran, Westminster, CA (US); Thinh Hoang, Ho Chi Minh City (VN)

(73) Assignee: The DIRECTV Group, Inc., El Segundo, CA (US)

(21) Appl. No.: 13/331,969

(22) Filed: Dec. 20, 2011

Related U.S. Application Data
(60) Provisional application No. 61/426,881, filed on Dec. 23, 2010.

(51) Int. Cl. H04N 17/00

(52) U.S. Cl. 348/181; 348/E17.001

(57) ABSTRACT

A system and method for testing a set top box includes a test manager module in communication with the set top box having a test script including a bitstream. A bitstream player in communication with the test manager module receives the bitstream and communicates the bitstream to the set top box. The test manager module receives a screen image from the set top box that is generated in response to the bitstream. An optical character recognition module performs optical character recognition to obtain a test text string from the screen image. The test manager module compares the test text string with an expected text string. A report module generates a report in response to comparing.

### TECHNICAL FIELD

The present disclosure relates generally to set top box testing and, more specifically, to performing an automated set top box test.

### BACKGROUND

The statements in this section merely provide background information related to the present disclosure and may not constitute prior art.

Providers of video service typically use set top boxes to decode the signals provided from a service provider. A service provider may provide service to a set top box from cable or satellite which is decoded and displayed to a screen display.

Technology for set top boxes changes often. The changes include both hardware modifications and software updates. For each software release a series of tests may be performed to not only assure the proper behavior of new features, but also a regression of existing functionalities. A number of bitstreams may be used to test the functionality of the set top box. Well over a thousand bitstreams may be used for testing various operating conditions of the set top box. Typically testing is performed manually by test operators. In an aggressive development cycle with numerous different types of set top boxes, the testing of new software with each type of set top box may not be feasible in a short amount of time.

One known way for performing testing of a set top box uses video or bit map comparisons of the captured screen against an expected image. One problem with this type of testing is that a slight adjustment in the user interface may require new screens to be recaptured before the system can properly validate the set top box. This is a time-consuming process and the management of these different images may become problematic when supporting many different types of set top boxes with slight variations in user interface requirements. A shift of just one pixel in the output image may generate an error. However, this slight shift may be due to a hardware change. Such a shift requires a new expected image for comparison. Reducing the amount of time for testing by reducing the reliance on video or bit map comparisons is desirable.

### SUMMARY

The present disclosure provides a system that provides an automated end-to-end system that may be used to validate set top box software that reduces the overall time for performing the test by reducing the reliance on video or bit map comparisons.

In one aspect of the disclosure, a method of testing a set top box includes generating a test script including a bitstream, communicating the bitstream to the set top box, generating a screen image in response to the bitstream, performing optical character recognition to obtain a test text string, comparing the test text string with an expected text string and generating a report in response to comparing.

In a further aspect of the disclosure, a system for testing a set top box includes a test manager module in communication with the set top box having a test script including a bitstream. A bitstream player in communication with the test manager module receives the bitstream and communicates the bitstream to the set top box. The test manager module receives a screen image from the set top box that is generated in response to the bitstream. An optical character recognition module performs optical character recognition to obtain a test text string from the screen image. The test manager module compares the test text string with an expected text string. A report module generates a report in response to comparing.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a high-level block diagrammatic view of the testing system for testing a set top box according to the present disclosure.

FIG. 2 is a block diagrammatic view of the automated set top box test manager illustrated in FIG. 1.

FIG. 3 is a flowchart of a method for performing a test according to the present disclosure.

FIG. 4 is a data flow diagram for the present disclosure.

FIG. 5 is a layout diagram of a report generated by the present disclosure.

### DETAILED DESCRIPTION

The following description is merely exemplary in nature and is not intended to limit the present disclosure, application, or uses. For purposes of clarity, the same reference numbers will be used in the drawings to identify similar elements. As used herein, the term module refers to an Application Specific Integrated Circuit (ASIC), an electronic circuit, a processor (shared, dedicated, or group) and memory that execute one or more software or firmware programs, a combinational logic circuit, and/or other suitable components that provide the described functionality. As used herein, the phrase at least one of A, B, and C should be construed to mean a logical (A or B or C), using a non-exclusive logical OR. It should be understood that steps within a method may be executed in different order without altering the principles of the present disclosure.

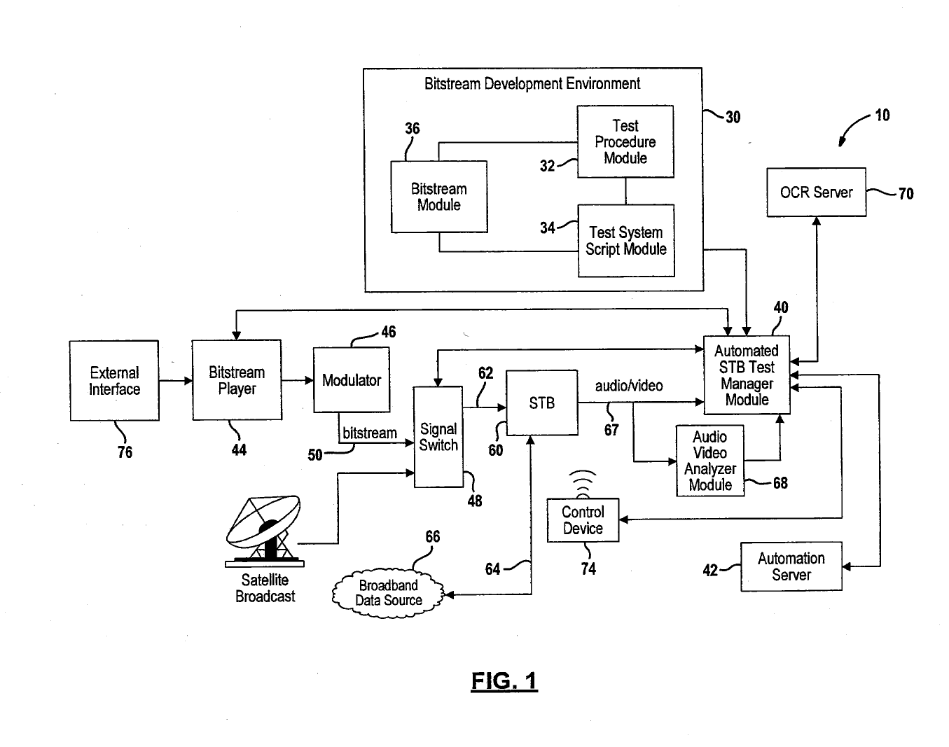

Referring now to FIG. 1, a system 10 for testing a set top box 20 is set forth. The system 10 includes a bitstream development environment 30. The bitstream development environment 30 may develop various test procedures and corresponding scripts and bitstreams for performing the desired testing for the set top box 10.

A test procedure module 32 may be included in the bitstream development environment 30. The test procedure module 32 generates the test procedure desired to be performed with the set top box. The test procedure module 32 may generate test procedures for testing various types of components within the set top box including, but not limited to, widgets, text boxes, labels and the like.

The test procedure module 32 may be coupled to a test system script module 34 which includes the test script to be used by various components within the testing system 10. The script may include the sequence of operations of the set top box and other components to obtain a desired screen image.

A bitstream module 36 may be in communication with the test procedure module 32 and the test system script module 34. The bitstream module 36 may provide the bitstreams, used by a set top box for providing the desired test and obtaining the desired screen image.

As illustrated in FIG. 1, the test system components are illustrated as separate boxes. However, the functionality of various boxes may be combined together in various numbers of components.

The output of the bitstream development environment 30 may be in communication with an automated set top box (STB) test manager (ASTM) module 40. The ASTM module 40 may be in communication with an automation server 42. In combination, the ASTM module 40 and the automation server 42 may perform the various tests, initiate actions, generate reports and log the progress. The automated set top box test manager module 40 may receive the execution results and generate a report in response to the results. The automation server 42 may provide a central control for specifying which tests the automated set top box test manager module 40 may perform. The images from inputs such as live broadcasts, broadband data, and bitstreams may be tested individually or in combination.

The automated set top box test manager module 40 provides bitstreams to the bitstream player 44 which is used to play out the various bitstreams to perform the testing according to the test script. The bitstream player 44 may be in communication with a modulator 46 for providing a modulated bitstream 50 to a signal switch 48. The signal switch 48 is capable of switching between various feeds including the modulated bitstream 50 and a satellite broadcast stream 52. The test script is used by the ASTM module 40 to control the signal switch 48.

The set top box 60 receives the switch signal 62 from the signal switch 48. The set top box 60 may also receive broadband data from a broadband data source 66.

The switch signal 62 may be used to generate an audio output and/or video image output from the set top box 60. The broadband data 64 may also be used to provide an audio output or video image output. The output 66 of the set top box 60 is provided to the automated set top box manager module 40 and an audio-video analyzer 68. The audio-video analyzer 68 may be used to validate certain audio or video playback. The output of the audio video analyzer 68 may be included in a test report as will be further described below.

The audio-video signal 67 is provided to the automated set top box manager module 40 which, in turn, provides the signal to the optical character recognition (OCR) server 70. The OCR server 70 generates a test text string in response to the video within the video signal 66. The OCR server 70 returns the test text strings or strings to the automated set top box manager module 40 for comparison with an expected text string. The expected test string or strings may be provided as part of the test script. In response to the comparison, a report may be generated.

The automated set top box test manager module 40 may also be in communication with a control device 74. The control device 74 may be an infrared device or an RF device. The control device 74 may generate control signals to the set top box 60. The control device 74 may simulate the actions of a remote control device. Sequences of simulated remote control key actuations may be used during the testing process.

The bitstream player 44 may also be in communication with an external interface 76. The external interface 76 may be used to access the bitstream player 44 and provide various bitstreams thereto. The external interface 76 may be controlled by external components or other components within the system such as the automation server 42.

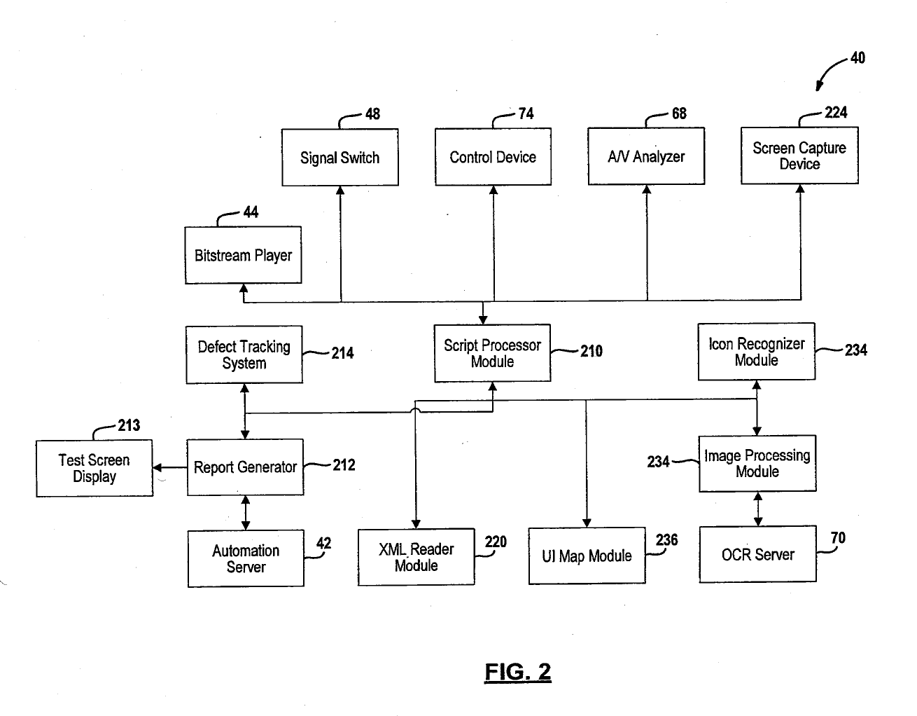

Referring now to FIG. 2, the automated set top box test manager (ASTM) module 40 is illustrated in further detail. In this embodiment, various modules included from FIG. 1 are labeled the same and perform the same function. These components will not be further described.

The automated set top box test manager module 40 includes a script processor module 210. The script processor module 210 processes the test scripts which may be in XML and translates each step in the script to a sequence of actions involving the various components.

Ultimately, the ASTM module 40 generates a report at the report generator 212. The report generator 212 receives the results of each test from the script processor module 210. A complete report pertaining to the execution of the tests at the instruction of the script processor may be generated upon script termination and displayed on a screen display 213. The screen display 213 may be a computer monitor at the test site or a monitor at a remote location. A paper report may also be generated.

The report generator 212 may also be in communication with a defect tracking system 214. The defect tracking system 214 may receive testing results according to verification failures. The defect tracking system 214 may be used to track and count various software defects. Should various defects occur regularly, the defect tracking system 214 may provide an indication of this.

The XML reader module 220 may be used by the script processor module 210 to parse and organize the test script which, in this example, is provided in XML. Each script may correspond to one bitstream procedure. The entire bitstream suite may be organized into various functional areas including the program guide which, in turn, may be divided into channel objects, program objects and schedule objects. The test scripts may not only contain the actions to be performed by the script processor module and other controlled components but also the expected data such as the expected text data, expected audio data and expected video data.

A screen capture device 224 may also be included within the ASTM module 40. The screen capture device 224 captures images of the screen displays that are generated by the set top box 60. Precise synchronization of the screen capture relative to the bitstream is not necessary since the bitstreams continue to carousel. Many of the bitstreams focus on the metadata rendered by the set top box and not the video and, therefore, it is not necessary for the screen capture to be precise such that a specific frame of the video is captured as was needed by prior systems. Such precision or lack thereof may generate unwarranted errors in prior systems. By way of example, once the screen display is set using the various components, the screen image may be captured but a particular frame is not required to be captured.

After the particular screen image is captured by the screen capture device 224, the image processing module 230 may process the image. The image processing module 230 may be used to perform image processing such as, but not limited to, cropping, inverting or converting the screen image. The image processing module 230 may be used in various testing scripts because the entire screen image may not be tested in all situations. For example, only the channel display area or display area smaller than the entire screen display may be required to be tested for a particular script.

The image processing module 230 provides the processed screen display image to the OCR server 70. The OCR server 70 is used to convert images to a test string or text strings so that the script processor module 210 may perform a comparison with the expected text string for the script.

An icon recognizer module 234 may be used to validate test steps that involve images that may not be able to be converted into tests. Validation may include comparing the icons from the screen display to expected screen display icons.

A user interface map module 236 may provide user interface dependent information such that the script processor module 210 may correctly trigger the set top box control sequences to perform the various validation test scripts. The user interface map module 236 is a memory that stores map input signals correlated with control sequences. The input signal initiates the proper command signal for the set top box. The UI map 236 allows the script processor to be decoupled from specific actions based on user interface variation. Thus, any changes to the user interface only affect the user interface map without changing the software within the ASTM module 40.

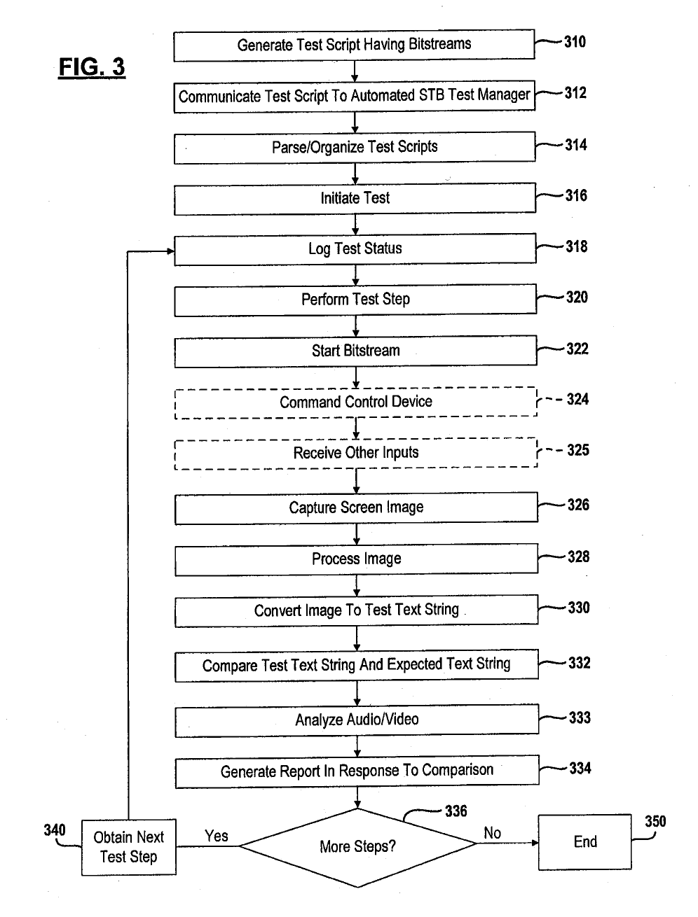

Referring now to FIG. 3, a flowchart of a method for performing a test is set forth. In FIG. 3, various test scripts having associated bitstreams are generated at the bitstream development environment 30 illustrated in FIG. 1 in step 310.

In step 312, a test script is communicated to the automated set top box manager (ASTM) 40. In step 314, the test scripts are parsed and organized. In step 316, a test is initiated by the ASTM 40. The test may be initiated by a test operator. The test status may be logged by the automation server in step 318. The test status may be logged at various points or steps for each script performed by the ASTM 40. In step 320, a test step may be performed by executing the script. In step 322, the bitstream may be communicated to the bitstream player 44. The bitstream player 44 may communicate the bitstream through a modulator 46 and the signal switch 48 illustrated in FIG. 1 before reaching the set top box 60. The bitstream is used to test a particular function by generating an output at the set top box.

To obtain the desired function, the control device may also be commanded to perform a particular action. For example, tuning to a particular channel may be commanded in step 324. In step 325 other inputs such as the broadband data or satellite video may be received at the set top box. The test and test report may be performed and generated in response to the bitstream and optional broadband data and satellite signals. Both steps 324 and 325 may be optional.

In step 326, a screen image may be captured. As described above, the screen image may also be processed in step 328. Processing the image may allow only a certain portion of the image to be used during the testing. Processing the image, as mentioned above, may include cropping, inverting or converting the image to enable optical character recognition. In step 330, the image or portions thereof are converted into a test text string. In step 332, the automated set top box test manager module 40 compares the test text string and the expected test string.

Optional step 333 may be performed when audio signals or video signals are to be analyzed. The audio-video analyzer 68 may be used when the bitstream requires the validation of audio or video signals or both. The audio or video signals may not be capable of being analyzed in a screen capture.

In step 334, a report is generated in response to the comparison. The report may also include an audio/video portion corresponding to the analyzed audio and video signals. An indicator in the report may provide an indication of whether the particular step has passed. The entire test procedure may perform a number of scripts with corresponding bitstreams. Therefore, a report may be generated that includes the results of the various scripts for various functions.

In step 336, if more steps are to be performed, step 340 obtains the next test step. The next step may be obtained by determining the next test script. After step 340, the status may be logged in step 318 and the next step is performed in step 320. The process repeats until all the steps are performed for the particular test. In step 336, when all of the steps are performed, step 350 ends the process.

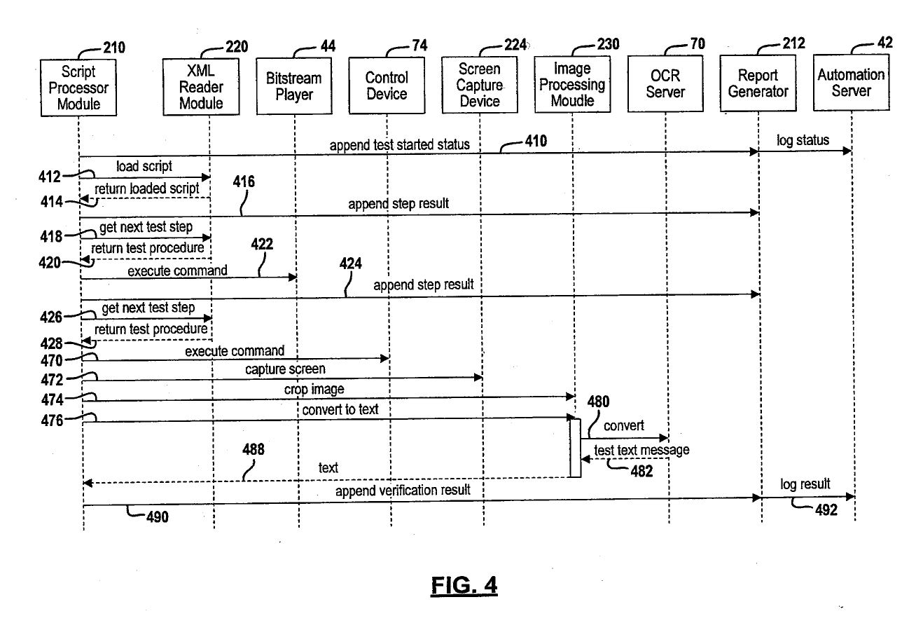

Referring now to FIG. 4, a signal diagram relative to the various components of the testing system is illustrated. In this figure, the various signals exchanged between the various components is set forth. After the test is initiated, a test started status signal 410 is communicated to both the report generator 212 and the automation server 42. The status is logged at the automation server 42. Thereafter, the script processor module 210 generates a load script signal 412 which is communicated to the XML reader module 220. As mentioned above, should a non-XML content be used, the reader for the particular formatted signal may be used. The XML reader module 220 returns a loaded script signal 414 to the script processor module for execution. A step result in step 416 is communicated to the report, generator 212 so that the results of the particular test step are performed. The next step is obtained in step 418 which returns the next step procedure from the XML reader module 220 in step 420. In step 422, the script processor module 210 communicates to the bitstream player 44 to execute the first step command. The step results are communicated in a step result signal 424 to the report generator 212 so a report may be generated. Thereafter, the next step is performed by generating a get next step signal 426 at the script processor module 210 which is communicated to the XML reader module 220. In step 428, the test procedure is returned to the script processor module 210. In step 430, the command is executed by the script processor module 210 to perform the next step by executing the next script. The command may communicate to the control device 74 to execute various functions. Step 470 is an optional step.

After the set top box is commanded in the pre-determined manner by the test sequence, in step 472 a screen capture signal is communicated from the script processor module 210 to the screen capture device 224. The screen capture device 224 captures a screen image. Thereafter, the image is communicated to the image processing module 230. The script processor module 210 may issue a crop image or image processing signal 474 which is used to process the image. After the image is cropped, step 476 converts the cropped image into text. A convert signal 480 may be provided to the OCR server 70 which returns a test text message 482. The text is provided to the script processor module using the text signal 488. Thereafter, the test text message is compared with the expected text string and the result is appended to the report at the report generator 212 in response to the append verification result signal 490. Thereafter, a log of the test results is provided from the report generator 212 to the automation server 42.

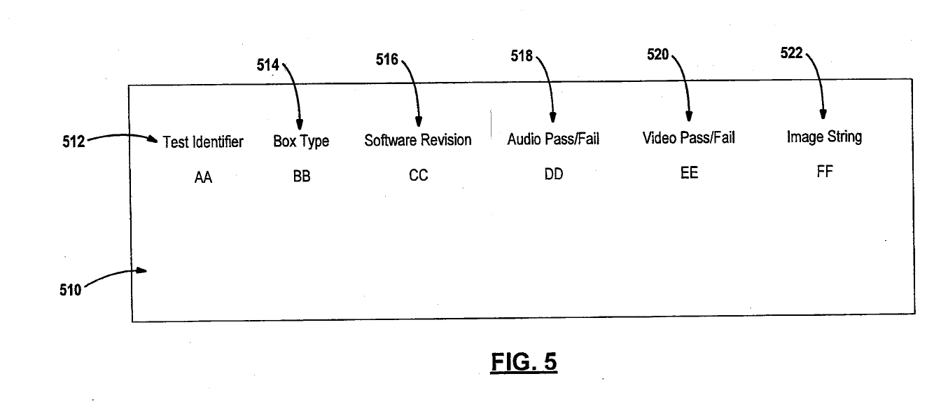

Referring now to FIG. 5, an example of a report 510 is illustrated having a test identifier 512, a box identifier 514, a software revision number 516, an audio pass-fail identifier 518, a video pass-fail identifier 520 and an image string pass-fail identifier. The report may be printed or displayed on a screen display of a computer. Although an audio pass-fail identifier 518 and video pass-fail identifier 520 are illustrated, they are optional and used when necessary for the particular test. Of course numerous results and parameters for different portions of a test may be displayed in a report depending on the system requirements.

Those skilled in the art can now appreciate from the foregoing description that the broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification and the following claims.

What is claimed is:

1. A method of testing a set top comprising:
generating a test script including a bitstream;
communicating the bitstream to the set top box;
generating a screen image in response to the bitstream;
performing optical character recognition to obtain a test text string;
comparing the test text string with an expected text string; and
generating a report in response to comparing.

2. A method as recited in claim 1 wherein prior to communicating the bitstream, communicating the test script and the bitstream to a test manager module.

3. A method as recited in claim 1 wherein prior to generating a screen image, controlling a control device with the test manager to provide a control input to the set top box and wherein generating the screen image comprises generating the screen image in response to the bitstream and the control input.

4. A method as recited in claim 1 wherein generating a screen image comprises generating a screen image in response to broadband data and the bitstream.

5. A method as recited in claim 1 further comprising controlling a switch with the test manager to switch between the bitstream and a satellite source.

6. A method as recited in claim 1 further comprising modulating the bitstream prior to the set top box.

7. A method as recited in claim 1 wherein prior to performing optical character recognition, processing the screen image.

8. A method as recited in claim 7 wherein processing the image comprises at least one of rotating and cropping the screen image.

9. A method as recited in claim 1 further comprising generating a test result in response to comparing and communicating the test result a defect module for indicating a defect in response to comparing.

10. A method as recited in claim 1 wherein generating comprises generating a report in response to analyzing an audio signal or video signal.

11. A system for testing a set top box comprising:
a test manager module in communication with the set top box having a test script including a bitstream;
a bitstream player in communication with the test manager module receiving the bitstream and communicating the bitstream to the set top box;
said test manager module receiving a screen image from the set top box that is generated in response to the bitstream;
an optical character recognition module performing optical character recognition to obtain a test text string from the screen image;
said test manager module comparing the test text string with an expected text string; and
a report module generating a report in response to comparing.

12. A system as recited in claim 11 further comprising a bitstream development environment communicating the test script and the bitstream to the test manager module.

13. A system as recited in claim 11 further comprising a control device that generates a control input to the set top box, said test manager controlling the control device to generate the control input, said test manager module receiving the screen image from the set top box that is generated in response to the bitstream and the control input.

14. A system as recited in claim 11 wherein a broadband data source communicated broadband data to the set top box and wherein the test manager module generates the screen image in response to broadband data and the bitstream.

15. A system as recited in claim 11 wherein the test manager module controls a switch to switch between the bitstream and a satellite source.

16. A system as recited in claim 11 further comprising a modulator modulating the bitstream to the set top box.

17. A system as recited in claim 11 further comprising an image processor processing the screen image prior to performing optical character recognition.

18. A system as recited in claim 17 wherein the image processor process performs at least of rotating and cropping the screen image.

19. A system as recited in claim 11 further comprising a defect module for indicating a defect in response to comparing.

20. A system as recited in claim 11 wherein the report module generates the report in response to analyzing an audio signal or video signal.
